(19) United States
(12) Patent Application Publication
(10) Pub. No.: US 2025/0044452 A1
(43) Pub. Date: Feb. 6, 2025

(54) SYSTEM FOR MONITORING THE INNER REFRACTORY LINING OF A VESSEL ADAPTED TO CONTAIN MOLTEN MATERIALS

(71) Applicant: MAGNESITAS NAVARRAS S.A., Zubiri (Navarra) (ES)

(72) Inventors: Jose Javier LECUONA, Zubiri (Navarra) (ES); Iker JAUREGUI, Zubiri (Navarra) (ES); Joseba RODRÍGUEZ, Zubiri (Navarra) (ES)

(73) Assignee: MAGNESITAS NAVARRAS S.A., Zubiri (Navarra) (ES)

(21) Appl. No.: 18/792,333

(22) Filed: Aug. 1, 2024

(30) Foreign Application Priority Data
Aug. 1, 2023 (ES) 202331421

(51) Int. Cl. G01S 17/89; B25J 19/02; F27D 21/00; G01D 5/347; G01S 7/481

(52) U.S. Cl. CPC G01S 17/89; B25J 19/022; F27D 21/0021; G01D 5/3473; G01S 7/4814; G01S 7/4817

(57) ABSTRACT

A system for monitoring an internal refractory lining of a vessel adapted to contain molten metal includes at least one LiDAR device orientable towards the refractory lining through an opening of the vessel, an external structure with respect to the vessel on which the at least one LiDAR device is mounted; and wherein the at least one LiDAR device includes: a laser source, an optical rotary encoder; a receiver configured to receive a laser beam reflected at the plurality of points on the surface of the refractory lining; and a controller to calculate a distance between the at least one LiDAR device and each of the plurality of points on the surface of the refractory lining.

### CROSS-REFERENCE TO RELATED APPLICATIONS

This application claims priority to Spanish utility model ES1304558U filed Aug. 1, 2023, which is pending and which is hereby incorporated in its entirety by reference for all purposes.

### TECHNICAL FIELD

Generally, the present invention relates to systems for supervising/monitoring the wear of the internal refractory lining of vessels using LIDAR devices for measuring said wear, preferably in steel and metal manufacturing sectors.

### BACKGROUND

Vessels or containers designed for containing materials at elevated temperatures, for example, at temperatures above the melting point of the material, are made of metal and internally lined with a refractory material to protect the metal part of the vessel from the high-temperature materials that it contains. However, due to the combined effects of oxidation, corrosion and mechanical abrasion generated by the high-temperature materials, part of the refractory surface in contact with the molten material may suffer gradual wear and deterioration. As a result, periodic inspections of the vessel, as well as repairs which prevent catastrophic damage, such as breakage of the vessel, must be performed. Inspections also seek to avoid the performance of scheduled periodic repairs that may be unnecessary. Furthermore, the costs associated with repairing the refractory lining are high. Moreover, repairing the refractory lining means stopping production processes (manufacturing downtime), which reduces the efficiency of manufacturing processes and increases costs.

Generally, inspection of the condition of the refractory lining of vessels has been performed visually by an experienced operator who looks for dark spots in the refractory lining which indicate high rates of heat transfer to the refractory material and to the vessel or the existence of significant wear in a particular area of the lining. Based on said visual inspection, the operator can determine the need to repair the lining. These manual techniques cannot be automated and systematised, require stopping the manufacturing processes for a long time since the vessel must be allowed to cool down before inspection can be carried out, expose the operator to risks and lack the desired precision since these techniques are based on the experience and subjective opinion of the operator.

Conventional measurement systems based on the use of time-of-flight (TOF) cameras, which project a light beam on the surface of the lining and generate depth maps based on the detection of light through standard RGB layers, usually collect a limited number of measurements corresponding to a limited number of points on the internal surface of the vessel, which can result in undetected wear in the spaces between the measured points on the refractory lining. Moreover, conventional measurement systems which use light sources typically use complex and predefined spatial coordinate systems for referencing the measurement heads (which incorporate light sources and possibly light detectors) in relation to the vessels and vice versa. Any movement of the measurement heads or of the vessel can result in invalid measurements being obtained, since the predefined spatial coordinate system is no longer valid.

### DESCRIPTION OF THE INVENTION

The object of the invention relates to a system for monitoring an internal refractory lining of a vessel adapted to contain molten metal. As it is used herein, the term “vessel” may refer interchangeably to any type of container, for example, iron and steel ladles, basic oxygen furnaces (BOFs), argon-oxygen decarburisation (AOD) vessels, electric arc furnaces (EAFs), aluminium and copper smelting vessels, smelting furnaces, torpedo cars (shaped ladles on rails, used to transfer molten iron from the blast furnace to steel making facilities) and bottom blown furnaces (Q-BOP), or any other type of vessels, adapted to contain high-temperature materials, for example, materials at temperatures above the melting point of the material, such as molten metals.

The term “refractory lining” may refer to a protective layer made of a refractory material that is generally installed in the vessel to protect the walls of the vessel from heat, pressures and chemical etching generated by the material contained in said vessel. The refractory lining can be installed in brick form covering the internal surface of the vessel or can be directly casted on the internal surface of the vessel. In turn, the term “refractory material” may refer to materials with a high thermal resistance and resistance to high temperatures. For example, the refractory material that is usually installed as an internal protective layer for the vessels can be magnesia-based (MgO) refractory materials that incorporate different magnesia aggregates and possibly some binders, andalusite-based (Al2SiO5) materials, magnesia combined with carbon-based refractory materials, etc. The working temperature of the refractory materials can reach 2000° C. or even higher. Specifically, the working temperature of refractory materials in the steel making industry can range between 1500 and 1800° C. More particularly, the gunning refractory material used for projection onto the internal surfaces of the vessel in order to repair the wear of the refractory lining can be made of any type of refractory material, for example, materials comprising sintered magnesia aggregates and binders or additives. This gunning refractory material can line the refractory slag line of the vessel or any other internal area of the vessel where the refractory lining must be repaired or reinforced.

The system object of the invention comprises at least one LiDAR device which can be oriented towards the refractory lining through an opening of the vessel and an external structure with respect to the vessel on which the at least one LiDAR device is mounted. The at least one LiDAR device comprises in turn a laser source configured to generate a pulsed laser beam and an optical rotary encoder configured to project the laser beam onto a plurality of points on a surface of the refractory lining through the opening of the vessel and a receiver configured to receive the laser beam reflected at the plurality of points on the surface of the refractory lining. The LiDAR device also comprises a controller configured to calculate a distance between the at least one LiDAR device and each of the plurality of points on the surface of the refractory lining. The controller can be a central processing unit (CPU), microprocessor or any other suitable hardware or software processing device.

As it is used herein, a LiDAR (Light Detection and Ranging or Laser Imaging Detection and Ranging) device is a device which allows determining the distance from a laser emitter to an object or surface using generally a pulsed laser beam. The distance to the object is determined by measuring the delay time between the emission of the pulse and the detection thereof through the reflected signal.

The laser beam projected by the LiDAR device onto the surface of the refractory lining creates a plurality of laser points on the surface of the refractory lining. The plurality of points generates a mesh of points which at least partially represent the surface of the refractory lining. This mesh (also known as a point cloud) can represent a portion of or the entire surface of the refractory lining of the vessel, depending on the portion of the refractory lining being monitored. Specifically, the mesh of points may correspond to a 3D representation of the portion of the surface of the refractory lining onto which the laser beam has been projected. The LiDAR devices capture the respective laser beams after being reflected at the plurality of points on the surface of the refractory lining and calculate the corresponding distance between each LiDAR device and each of the plurality of points on the surface of the refractory lining. More specifically, the controller of the LiDAR device measures the time it took for the laser beam to travel from the laser source of the LiDAR device to the surface of the refractory lining and back to the LiDAR device. These LiDAR devices are capable of generating meshes with many more points in the same time period compared to other solutions of the prior art such as time-of-flight cameras. This larger number of points results in much more precise and accurate meshes, so the resolution of the 3D representation of the obtained lining is improved.

Preferably, the thickness of the refractory material is measured by means of the system object of the invention during the inactivity periods of the vessel, in other words, when the vessel is empty or when only some material remains at the bottom (liquid heel) after emptying the vessel.

In some embodiments, the system also comprises at least one memory and at least one processor, such that the at least one memory is configured, with the at least one processor, to carry out the generation, with the plurality of points on the surface of the refractory lining, of a mesh which at least partially represents the surface of the refractory lining; and the determination of an actual thickness of the refractory lining at the plurality of points on the surface from the calculated distances and the corresponding pre-established distances between the at least one LiDAR device and the plurality of points on the surface of the refractory lining. The processor can be a central processing unit (CPU), microprocessor or any other suitable hardware or software processing device. Pre-established distances are the distances between the LiDAR devices and the laser points projected onto the surface of the refractory lining measured before the vessel comes into operation, and therefore before the refractory lining suffers any wear. Since the thickness of the refractory lining (without being subjected to wear), and therefore the distance between the LiDAR device and the surface of the refractory lining at any point of said surface, is known, the actual thickness of the refractory lining at those points can be derived by determining the actual distances between the LiDAR device and the worn surface of the refractory lining. before the refractory lining wears out. The at least one processor and the at least one memory can be located remotely with respect to the LiDAR device such that the thermal, electromagnetic and light radiations emitted by the vessel do not affect these components.

In some embodiments, the external structure is a robotic arm movable from a first position located away from the opening of the vessel to a second position located at a height over the opening of the vessel. Preferably, the system comprises a single LiDAR device mounted on a free end of the robotic arm. For example, the robotic arm can be an extendible telescopic arm or a pivoting arm that only extends and is located over the opening of the vessel when the vessel is empty and the monitoring operation will be performed. For example, the free end of the robotic arm can be located 3 metres over the opening of the vessel to ensure that the heat from the vessel does not damage the LiDAR devices. The free end of the robotic arm can also be located centred in relation to the opening of the vessel to ensure that the laser beams projected by the LiDAR devices can cover the entire surface of the refractory lining.

In some embodiments, the external structure is a fixed structure located close to the opening of the vessel. Preferably, the fixed structure will be located at least partially at a predetermined distance over the opening of the vessel.

In some embodiments, the system comprises two LiDAR devices mounted on the fixed structure, wherein each LiDAR device is oriented to scan, with the laser beam, a corresponding half of the internal refractory lining of the vessel.

In some embodiments, the system comprises a first LiDAR device which can be oriented on a first portion of the surface of the refractory lining and which is configured to project a first laser beam onto the first portion generating a first mesh which represents the first portion. Furthermore, the system comprises a second LiDAR device which can be oriented on a second portion of the surface and which is configured to project a second laser beam onto the second portion generating a second mesh which represents the second portion. The second portion of the surface of the lining will be different from the first portion. The at least one memory will also be configured, with the at least one processor, to combine the first mesh and the second mesh, creating a third mesh which represents a combination of the first and second portions. For example, the first LIDAR device can be configured to project its laser beam onto the half of the surface of the refractory lining to generate a first mesh which represents said half portion of the surface of the refractory lining and the second LiDAR device can be configured to project its laser beam onto the other half of the surface of the refractory lining to generate a second mesh which represents said other half portion of the surface of the refractory lining. By combining said first and second meshes, a third mesh which represents the entire surface of the refractory lining is obtained. In some other embodiments, a different number of LiDAR devices which project respective laser beams onto the surface of the refractory lining of the vessel, said laser beams scanning over portions of the surface of the refractory lining having the same or different geometry, shape or size, can be used to obtain corresponding meshes which can be combined to generate larger meshes that represent combined portions of the refractory lining of the vessel. To combine said meshes, the processor can use a predefined reference system for correctly locating a mesh in relation to the other meshes.

In some embodiments, the at least one LiDAR device has a circular field of view extending at least 70° vertically and horizontally.

In some embodiments, the at least one LiDAR device has a maximum detection range of 5 cm.

In some embodiments, the LiDAR device is integrated inside a measurement head and wherein the measurement head comprises thermal insulation means.

In some embodiments, the at least one memory is configured, with the at least one processor, to generate a 3D map which represents the wear on the surface of the refractory lining. This 3D map is based on the result from comparing the generated mesh and the predefined mesh. The 3D map represents the wear on the surface of the lining based on the differences between the distances obtained for the points of the generated mesh and the distances obtained for the corresponding points of the predefined mesh. This 3D map can represent the profile of the surface of the refractory lining with different colours according to the wear measured. To show a more accurate representation of the profile of the surface of the refractory lining, the processor will be able to interpolate the values of the differences obtained for the corresponding points, obtaining other intermediate values that will also be used to generate the 3D map. The 3D map may also comprise a colour code notifying about the degree of wear suffered by the surface of the refractory lining. For example, dark grey colour can be assigned to those areas of the 3D map having wear exceeding a predefined threshold, e.g., 5 cm, and the darkest grey colour can be assigned to those areas of the 3D map having wear below another predefined threshold, e.g., 2 cm. Other colours, such as different shades of grey, can be assigned to areas of the 3D map having wear ranging from 5 to 2 cm, depending on other predefined thresholds. Therefore, the 3D map provides an intuitive and visual representation of the integrity status of the refractory lining and a user can easily decide in which areas of the refractory lining a gunning operation is recommended or required. Similarly, the processor can automatically determine in which areas of the refractory lining a gunning operation may be recommended or required based on the mentioned or other thresholds.

In some embodiments, the LiDAR devices may comprise physical filters, such as zirconium dioxide filters, to filter and shield from the electromagnetic and light radiations that they may receive from the vessel during the monitoring operation. The LiDAR devices may further comprise digital filters, centred on the laser emission frequency peaks thereof, in order to reduce the spectral noise received and to filter deviated measurements generated by, for example, metal particles suspended in the vessel and in the area surrounding the opening of the vessel.

In some embodiments, the measurement head may comprise a guiding system which allows orienting the measurement head with respect to the vessel. Preferably, the guiding system will be coordinated with the optical rotary encoder to scan, with the pulsed laser beam, the surface of the refractory lining of interest. This guiding system can be a stepper motor with a rotating shaft among other guiding systems of the prior art.

In some embodiments, the measurement head can be cooled. The cooled measurement head ensures that the electronics of the LiDAR devices and the guiding system are not damaged by the heat from the vessel. This further allows said head to be located closer to the opening of the vessel, improving the quality of the measurement obtained and the efficiency of refractory lining monitoring.

In some other embodiments, three LiDAR devices may be located at a height and in an equidistant manner with respect to one another around the opening of the vessel. For example, the three LiDAR devices can be integrated into three respective measurement heads, that can be coupled to an external structure with respect to the vessel or to a mobile robotic arm. The three LiDAR devices will be located at a height which ensures that the heat from the vessel does not damage their optics or electronics. The three LiDAR devices are located in an equidistant manner with respect to one another around the opening of the vessel to ensure that the projected laser can scan, in a complementary manner (each laser covers about one-third of the total surface), the entire surface of the refractory lining.

The solution described herein can be used in the integrated steel, iron and steel, glass, metallurgical, cement, waste treatment, ceramic and petrochemical industries, among many others. In other words, it can be used in any industry that uses vessels in which the material they contain melts or at least reaches temperatures high enough so as to make the existence of an internal refractory lining necessary.

### BRIEF DESCRIPTION OF DRAWINGS

To complete the description and to provide a better understanding of the invention, a set of figures is included. Said figures form an integral part of the description and illustrate an embodiment of the invention, which must not be interpreted as limiting the scope of the invention, but simply as an example of how the invention can be carried out. The drawings comprise the following figures:

FIG. 1 shows a system for monitoring an internal refractory lining of a vessel, according to a particular embodiment of the invention.

FIG. 2 shows a portion of the surface of the refractory lining onto which a pulsed laser beam is projected, according to a particular embodiment of the invention.

FIG. 3 shows a front perspective view of a measurement head which includes a LIDAR device to monitor the wear on the surface of the refractory lining of a vessel, according to a particular embodiment of the invention.

FIG. 4 shows an exploded view of the measurement head 300 shown in FIG. 3.

FIGS. 5A and 5B show a generated 3D map which represents the wear of a portion of the surface of the refractory lining of a vessel, according to a particular embodiment of the invention.

### DETAILED DESCRIPTION OF THE INVENTION

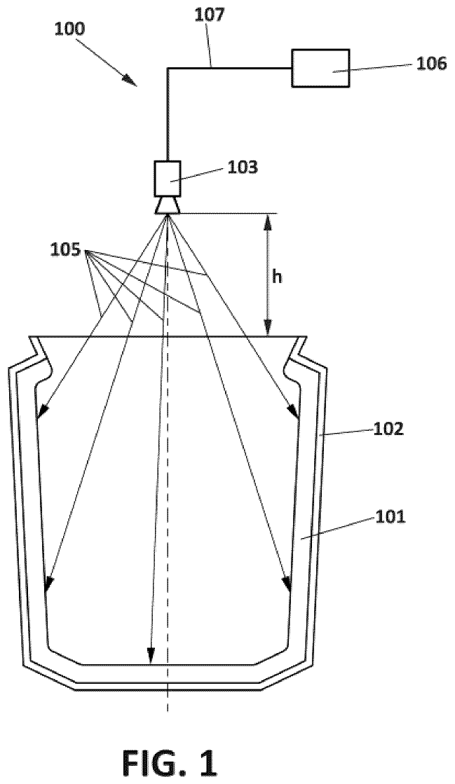

FIG. 1 shows a system 100 for monitoring an internal refractory lining 101 of a vessel 102. The vessel 102 is made of a metal or a metal alloy that can withstand very high temperatures and its internal surface is lined with a refractory material layer 101 which can be installed in brick form, lining the internal surface of the vessel 102, or can be casted or projected directly onto the internal surface of the vessel 102. This refractory material layer 101 protects the vessel 102 from heat, pressures and chemical etching of the molten materials deposited therein. The refractory material layer 101 substantially covers the internal surface of the vessel 102.

The system 100 comprises a LiDAR device 103 which is located centred at a height (h) relative to the opening 104 of the vessel 102, for example, 3 metres over the plane defined by the opening 104 of the vessel 102. This position of the LiDAR device with respect to the opening 104 of the vessel 102 allows the LiDAR device 103 to project its laser beam 105 onto the entire surface of the refractory material layer 101. The LiDAR device 103 comprises a laser source emitting a laser beam with a wavelength in the infrared spectrum, preferably between 800 nm and 1 mm and more preferably about 905 nm and emits an average power of about 8 W. The LiDAR device 103 will be configured to process up to 200,000 points per second. Emitting in the infrared spectrum and with this average power ensure that the laser beams projected onto the material of refractory lining 101 are not concealed (masked) by the intense light radiation generated inside the vessel, such that the LiDAR device 103 is capable of gathering the reflected laser beams. By way of example, the LiDAR device 103 can project its laser beam onto the surface of the refractory lining for about 7 seconds and can project about 1,400,000 points onto the surface of the refractory lining per monitoring cycle. By exposing the LiDAR device 103 to the empty vessel for periods of about 7 seconds, the optics and electronics of the LIDAR device 103 are not affected by the thermal, electromagnetic and light radiations emitted by the vessel 102.

The LiDAR device 103 is wired to a processor 106 which can be located in a control room located in the industrial facility. The cable connection 107 between the LiDAR device 103 and the processor 106 minimises the effect of magnetic disturbances generated by the molten material in the vessel or by the heat irradiated by the vessel even when it is empty. Additionally, the cable connection 107 may comprise an electromagnetic shield to improve the quality and reliability of the signals received in the processor 106. The LiDAR device 103 comprises a molybdenum dioxide filter (not shown in this figure) to filter and shield from the light and electromagnetic radiations received from the vessel 102. Furthermore, the LiDAR device 103 comprises a digital filter centred on the laser emission frequency, for example, the frequency corresponding to the emission wavelength of 905 nm, to reduce the spectral noise received.

The LiDAR device 103 can be located with respect to the vessel 102 by means of a robotic arm (not shown in the figure) during the inactivity periods of the vessel 102 to then be separated from the vessel during the production periods. As an alternative, the LiDAR device 103 can be coupled to a fixed structure (not shown) external to the vessel 102.

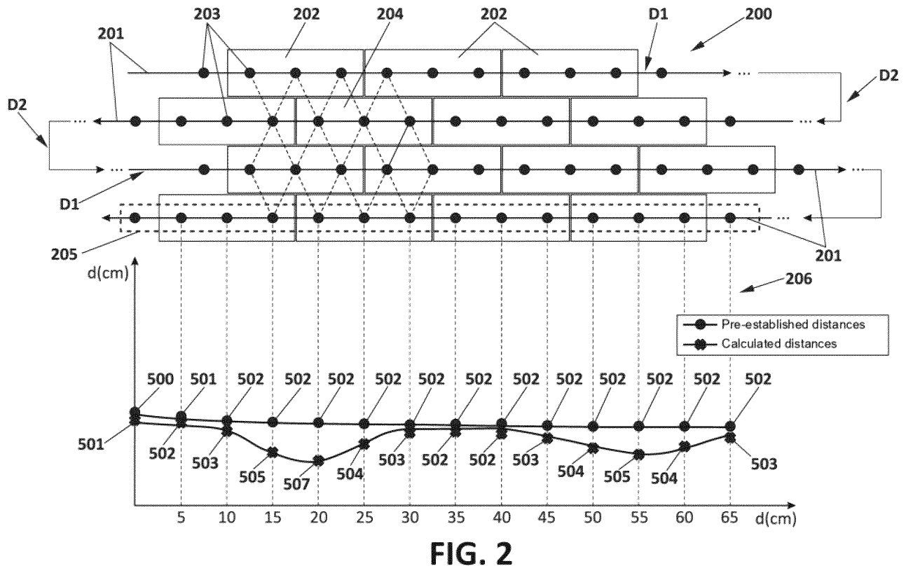

FIG. 2 shows a portion of the refractory lining layer 200 onto which a pulsed laser beam 201 is projected, according to a particular embodiment of the invention. The refractory lining layer 200 is formed by a plurality of bricks 202 made of a refractory material. For example, the bricks 202 can be made of a magnesia-based (MgO) refractory material. The LiDAR device (not shown in this figure) is configured to project a laser beam 201 which generates three laser points 203 on the surface of each brick 202 of the refractory lining layer 200. In such embodiment, the bricks 202 have a length of 20 cm and a width of 5 cm, such that the distance between the laser points 203 is about 5 cm. The plurality of laser points 203 projected onto respective points of the bricks 202 generates a mesh 204 which represents the portion of the surface of the refractory lining layer 200 onto which the laser beam 201 is projected. The laser beam 201 moves in a 2D serpentine pattern on the surface of the refractory lining.

The refractory profile of the array of laser points 205 is shown in the graph 206 below. In such embodiment, the LiDAR device is located 3 metres above the opening of the vessel (as shown in FIG. 1) and the portion being monitored is about three metres below the plane defined by the opening of the vessel. Therefore, the portion of the refractory lining layer 200 which is monitored is about 6 metres below the LiDAR device. Next, the laser points 203 of the pre-established mesh (mesh generated before the wear of the refractory lining layer) are projected onto the surface at a distance of the LiDAR device ranging from 600 to 602 cm. Once the refractory lining layer 200 has been subjected to wear, the distances at which the same points of the refractory lining layer 200 of the LIDAR device (which is located in the same position relative to the vessel as when the pre-established distances were obtained) are located range from 601 to 607 cm. Therefore, by comparing the respective pre-established and calculated distances for each point, the wear of the refractory lining layer 200 can be obtained. This wear ranges from 0 to 5 cm.

The number of lines per mesh or the number of points per line can be increased or reduced according to the time the LiDAR device is exposed to the inside of the vessel or the accuracy requirements. Additionally, point density may vary according to the area of the vessel scanned by the LiDAR devices. For example, the LiDAR devices can project a larger number of laser points onto those areas of the refractory lining layer subjected to significant wear.

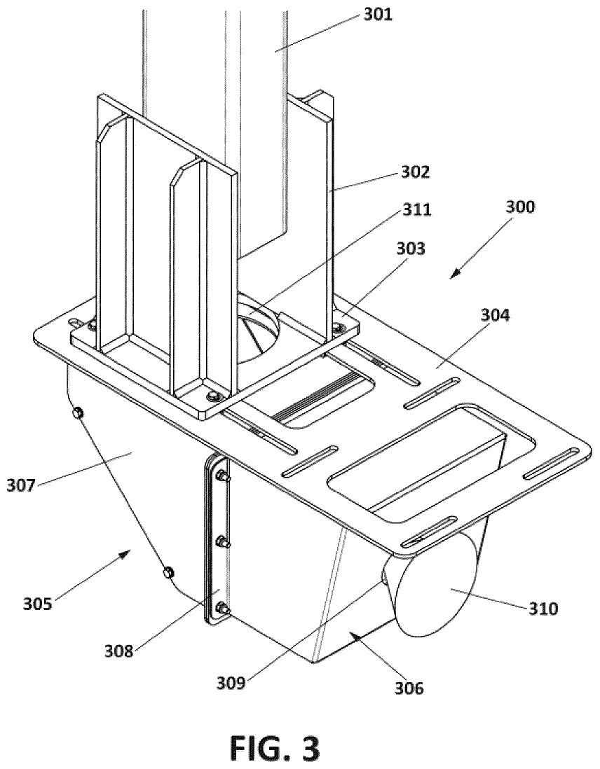

FIG. 3 shows a front perspective view of a measurement head 300 which includes a LIDAR device (not shown in this figure) therein for monitoring the wear on the surface of the refractory lining of a vessel, according to a particular embodiment of the invention.

The measurement head 300 is coupled to the free end of a robotic arm 301. The robotic arm 301 can be an extendible telescopic arm or a pivoting arm, among other types of arms, which is configured to be extended and located over the opening of the vessel when the vessel is empty and the monitoring operation will be performed. The free end of the robotic arm 301 can be located, for example, at least three metres over the opening of the vessel to ensure that the heat from the vessel does not damage the LiDAR devices. The distance at which the supervision head 300 is located over the opening of the vessel may depend on the temperature reached by the vessel during the production process, and therefore its temperature during the inactivity periods. The free end of the robotic arm 301 can also be located centred in relation to the opening of the vessel to ensure that the laser beams projected by the LiDAR device can cover the entire surface of the refractory lining. As an alternative, the measurement head 300 can be attached to a fixed structure located close to the vessel and can be located centred or off-centred with respect to the opening of the vessel.

The measurement head 300 is coupled to the free end of the robotic arm 301 by means of a U-shaped adaptor 302 where the side portions of the U-shaped adaptor 302 are attached by means of, for example, screws or welding, to the free end of the robotic arm 301. Furthermore, the bottom portion 303 of the U-shaped adaptor 302 is coupled to a metal plate 304 having larger dimensions than the bottom portion 303 and projecting forward in the laser beam emission direction of the LiDAR device. The measurement body 305 where the LiDAR device is housed is coupled to the metal plate 304. This measurement body 305 is formed by a front casing 306 and a rear casing 307 which are attached by means of respective flanges 308 that are screwed together. The front casing 306 of the measurement body 305 has a front hole 309 closed with a glass through which the laser beam emitted by the LiDAR device is projected. Cone 310 is a representation of the field of view or opening of the emission beam of the LiDAR device when it is in operation.

While the measurement head 300 shown in FIG. 3 comprises a single LIDAR device, other embodiments may comprise a different number of LiDAR devices arranged at a specific angle or orientation with respect to one another. Furthermore, other embodiments can use one measurement body 305 or several measurement bodies, each of them integrating one or more LiDAR devices. The geometry of the measurement bodies 305 may vary from one embodiment to another.

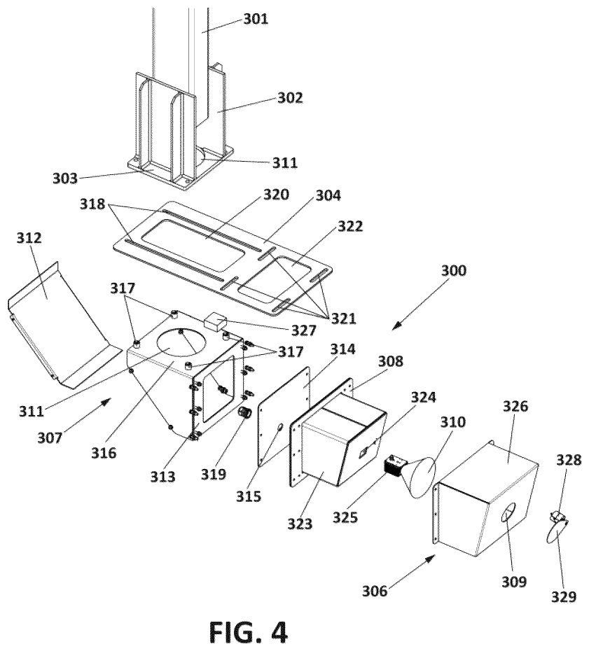

FIG. 4 shows an exploded view of the measurement head 300 shown in FIG. 3.

Both the bottom portion 303 of the U-shaped adaptor 302 and the upper wall 316 of the rear casing 307 have respective holes 311 through which there pass power cables and cables for communication with the processor (not shown in this figure), as well as any other cables that may be needed for the proper operation of the measurement body 305 such as, for example, cooling cables through which a liquid coolant flows to keep the LiDAR device cooled, etc.

The rear casing 307 has a rear wall 312 which can be removed to access the inside of said rear casing 307 and to enable coupling/uncoupling the measurement body 305 with respect to the metal plate 304. Furthermore, it comprises a flange-like front wall 313 extending towards the inside thereof for being coupled, by means of screws, to an intermediate wall 314 demarcating the spaces defined by the rear casing 307 and the front casing 306. This intermediate wall 314 has dimensions that are slightly smaller than external perimeter of the front wall 313 such that the intermediate wall 314 does not protrude from the rear casing 307. The intermediate wall 314 has a through hole 315 to which there is screwed a connector 319 which allows the connection of the power and communication wiring of the LiDAR device 325, of the pneumatic motor 328 and of the cooling circuit of the measurement head 325 on both sides of the intermediate wall 314. The cover 312 also allows access to these connections from the rear casing 307 without having to disassemble the measurement body 305. In other embodiments, the intermediate wall 314 can have more than one through hole with its corresponding connector, each of them for a different cable.

The upper wall 316 of the rear casing 307 has four pin-like protuberances 317 which are inserted into respective longitudinal guides 318 located in the metal plate 304 and which, once fixed by means of screws or other fixing means, allow the movement and fixing of the measurement head 305 along the length of said guides 318. The metal plate 304 also has a hole 320 having a width corresponding with the diameter of the holes 311 but having a longer length to allow the passage of the wiring through the mentioned holes 311 when the measurement body 305 moves forward and backward along the guides 318. Furthermore, the metal plate 304 has transverse guides 321, wherein alternatively the protuberances 317 of the rear casing 307 and a corresponding hole 322 can be inserted and coupled, to allow the passage of the wiring, allowing the measurement head 305 to be able to move transversely along said guides 321. These guides 318, 321 with their respective holes 320, 322 allow the measurement body 305 to be coupled to the free end of the robotic arm 301, allowing position corrections in both longitudinal and transverse directions.

The front casing 306 is formed by an internal body 323 where the LiDAR device 325 is housed and the pneumatic motor 328 that is used to drive a protective cover 329 which opens when taking measurements and closes when the LiDAR device is inactive, thereby preventing heat and electromagnetic radiation from reaching the glass located in the hole 309 for longer than necessary. The inside of the internal body 323 will be cooled with the cooling cables to prolong the service life of both the LiDAR device 325 and the pneumatic motor 328. The LiDAR device 325 is inserted into the hole 324 such that only the front part thereof protrudes from said hole 324. The external body 326 of the front casing 306 has dimensions slightly larger than the internal body 323 such that a cavity is defined between both where thermal protection means such as, for example, a thermal blanket, can be inserted. Both the internal body 323 and the external body 326 of the front casing 306 are screwed to the front wall 313 of the rear casing 307 through the corresponding flanges 308. The levelling plug 327 is used to facilitate the coupling of the upper wall 316 of the rear casing 307 to the metal plate 304.

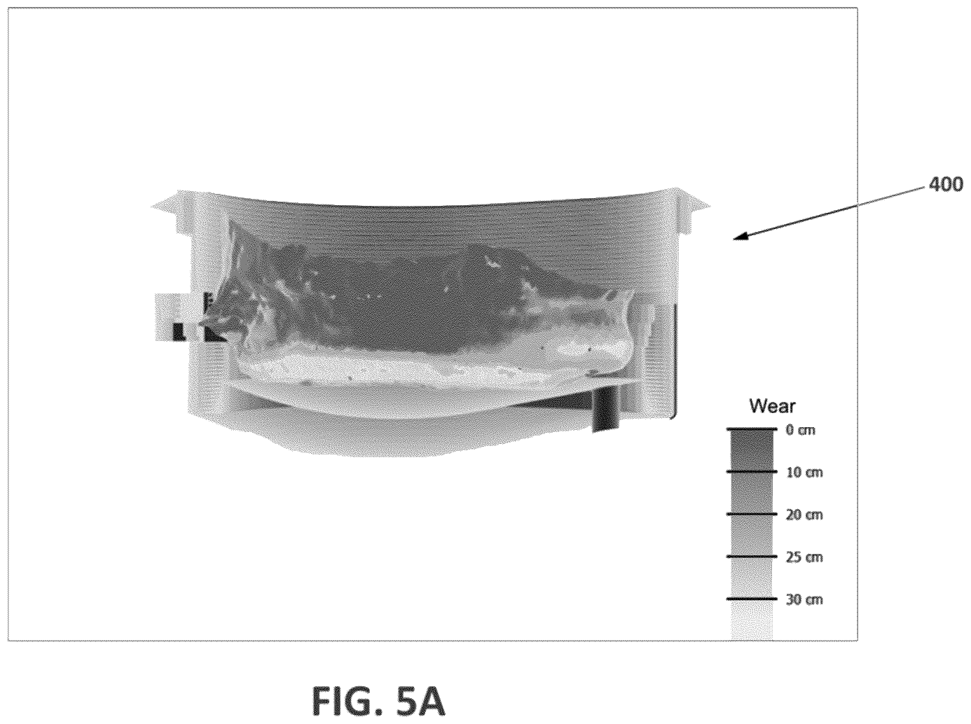

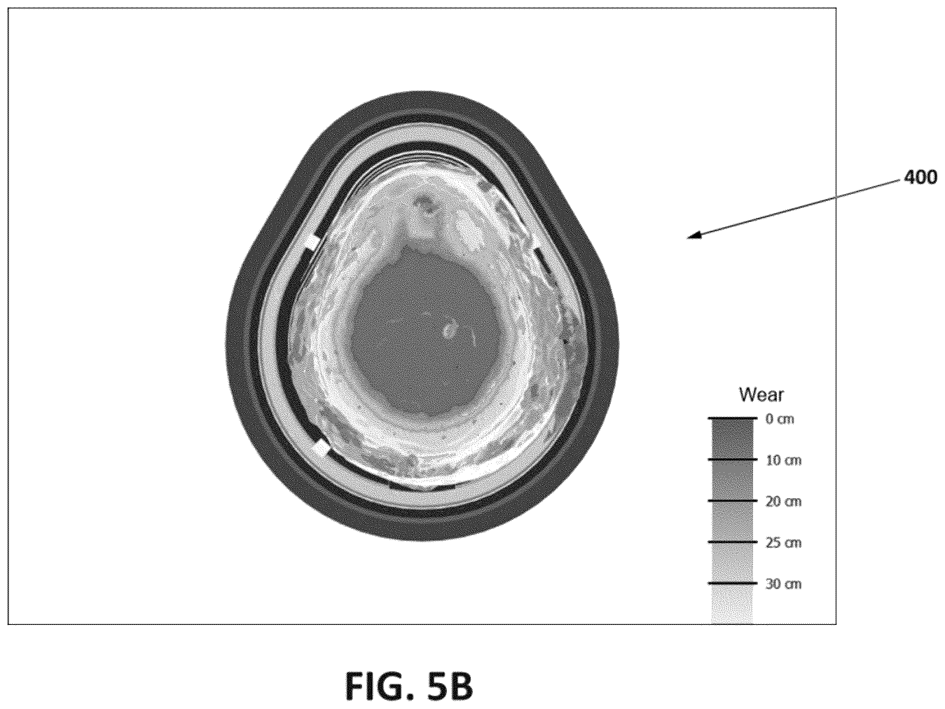

FIG. 5A shows a side view of a 3D map 400 corresponding to a portion of a vessel, for example, a smelting furnace vessel, obtained with the system 100 for monitoring a refractory lining, object of the present invention. The 3D map 400 represents the wear of a portion of the surface of the refractory lining of the vessel, according to a particular embodiment of the invention. This map is generated from refractory material thickness measurements obtained by system 100. FIG. 5B shows a plan view of that same smelting furnace vessel.

The degrees of wear obtained for a vessel after the measurement thereof during furnace downtime are shown in different colours. Therefore, it can be seen that the areas of the vessel closest to the bottom show wear on the internal refractory material of about 30 cm, whereas in the uppermost areas of this portion of the vessel the wear is between 0 and 10 cm. The bottom of the vessel in FIG. 5A is shown in a darker colour as it corresponds to the liquid heel, i.e., molten material residue remains at the bottom of the vessel at the time of measurement making measurement in that area impossible. In FIG. 5B, this liquid heel appearing at the bottom of the vessel is the darkest grey in colour corresponding to wear of 0 cm.

Based on this map, the system will automatically or an operator will manually make the decision on the need to gun certain areas of the refractory material. In some embodiments, certain wear thresholds could be established, for example 20 cm, such that an autonomous gunning system by means of a robotic arm, which is introduced into the vessel and controlled by a processor that is provided with the generated 3D map 400, can automatically gun those areas having wear equal to or greater than 20 cm.

In the present text, the term “comprises” and its derivatives (such as “comprising”, etc.) should not be understood in an excluding sense, in other words, these terms should not be interpreted as excluding the possibility that what is described and defined may include other elements, steps, etc. The term “other”, as it is used herein, is defined as at least a second or more. The term “coupled”, as it is used herein, is defined as connected, either directly without any intervening element or indirectly with at least one intervening element, unless otherwise indicated. Two elements can be coupled mechanically, electrically or communicatively linked through a communication channel, route, network or system.

The invention is obviously not limited to the specific embodiments described herein, but rather encompasses any variation that may be contemplated by those skilled in the art (for example, in terms of the choice of materials, dimensions, components, configuration, etc.), within the general scope of the invention as defined in the claims.

1. A system for monitoring an internal refractory lining of a vessel adapted to contain molten metal, comprising:
at least one LiDAR device orientable towards the refractory lining through an opening of the vessel,
an external structure with respect to the vessel on which the at least one LiDAR device is mounted; and
wherein the at least one LiDAR device comprises:
a laser source configured to generate a pulsed laser beam,
an optical rotary encoder configured to project the laser beam on a plurality of points on a surface of the refractory lining through the opening of the vessel;
a receiver configured to receive the laser beam reflected at the plurality of points on the surface of the refractory lining; and
a controller configured to calculate a distance between the at least one LiDAR device and each of the plurality of points on the surface of the refractory lining.

2. The system according to claim 1, comprising at least one memory and at least one processor.

3. The system according to claim 1, wherein the external structure is a robotic arm movable from a first position located away from the opening of the vessel to a second position located at a height over the opening of the vessel.

4. The system according to claim 3, comprising a single LiDAR device mounted on the robotic arm.

5. The system according to claim 1, wherein the external structure is a fixed structure located close to the opening of the vessel, the fixed structure preferably being located at least partially at a predetermined distance over the opening of the vessel.

6. The system according to claim 5, wherein the system comprises two LiDAR devices mounted on the fixed structure, wherein each LiDAR device is oriented to scan, with the pulsed laser beam, a corresponding half of the internal refractory lining of the vessel.

7. The system according to claim 6, wherein:
a first LiDAR device can be oriented on a first portion of the surface of the refractory lining; and
a second LiDAR device can be oriented on a second portion of the surface.

8. The system according to claim 5, comprising three LiDAR devices mounted on the fixed structure and placed at a height and in an equidistant manner with respect to one another around the opening of the vessel.

9. The system according claim 1, wherein the at least one LiDAR device has a circular field of view extending at least 70° vertically and horizontally.

10. The system according to claim 1, wherein the at least one LiDAR device has a maximum detection range of 5 cm.

11. The system according to claim 1, wherein the LiDAR device is integrated inside a measurement head and wherein the measurement head comprises thermal insulation means.

12. The system according to claim 11, wherein the measurement head comprises cooling means.

13. The system according to claim 12, wherein the measurement head comprises a guiding system for positioning the measurement head with respect to the vessel.

14. The system according to claim 13, wherein the guiding system is configured to work in a coordinated manner with the optical rotary encoder of the at least one LiDAR device.

15. The system according to claim 1, wherein the at least one LiDAR device comprises physical filters, preferably zirconium dioxide or molybdenum dioxide filters, to filter and shield from the electromagnetic and light radiations coming from the vessel.

16. A method for monitoring an internal refractory lining of a vessel adapted to contain molten metal, comprising:
providing at least one LiDAR device that is orientable towards the refractory lining through an opening of the vessel,
providing an external structure with respect to the vessel on which the at least one LiDAR device is mounted; and
generating, by a laser source of the at least one LiDAR device, a pulsed laser beam;
projecting, by an optical rotary encoder of the at least one LiDAR device, the laser beam on a plurality of points on a surface of the refractory lining through the opening of the vessel;
receiving, by a receiver of the at least one LiDAR device, the laser beam reflected at the plurality of points on the surface of the refractory lining; and
calculating, by a controller of the at least one LiDAR device, a distance between the at least one LiDAR device and each of the plurality of points on the surface of the refractory lining.

17. The method according to claim 16, comprising:
positioning, by means of a robotic arm, the at least one LiDAR device at a first position located away from the opening of the vessel while the at least one LiDAR device is not monitoring the internal refractory lining of the vessel; and
moving, by the robotic arm, the at least one LiDAR device to a second position located at a height over the opening of the vessel when the at least one LiDAR device is to monitor the internal refractory lining of the vessel.

18. The method according to claim 16, comprising:
providing two LiDAR devices mounted on the fixed structure;
orienting each LiDAR device so as to scan a corresponding half of the internal refractory lining of the vessel; and
scanning, with a respective pulsed laser beam emitted by each LiDAR device, the corresponding half of the internal refractory lining of the vessel.

19. The method according to claim 16, comprising:
providing a measuring head in which the at least one LiDAR device is housed, the measuring head comprising a guiding system for positioning the measurement head with respect to the vessel; and
operating the guiding system to work in a coordinated manner with the optical rotary encoder of the at least one LiDAR device.
